(19) United States
(12) Patent Application Publication
(10) Pub. No.: US 2008/0052030 A1
(43) Pub. Date: Feb. 28, 2008

(54) Method of predicting an incontinent event

(75) Inventors: Christopher P. Olson, Neenah, WI (US); Andrew M. Long, Appleton, WI (US)

Correspondence Address: KIMBERLY-CLARK WORLDWIDE, INC.;Catherine E. Wolf, 401 NORTH LAKE STREET, NEENAH, WI, 54956, US

(73) Assignee: Kimberly-Clark Worldwide, Inc.

(21) Appl. No.: 11/508,670

(22) Filed: Aug. 22, 2006

(51) Int. Cl. G06F 19/00

(52) U.S. Cl. 702/127; 702/1; 702/189

(57) ABSTRACT

Many types of continence training methods and aids have been utilized, including progress charts, reward systems, urination “targets” for boys, electronic wetness alarms, progress scales, readiness questionnaires, and thermal and tactile training signals in disposable absorbent products, among many others. A key step in urinary continence training, in particular, is helping the child to learn to associate the physiological sensation of a “full” bladder with voluntary urination.

### BACKGROUND

Newborn babies are incontinent, i.e., they are unable to voluntarily retain their bodily discharges and, instead, urinate and defecate reflexively. As they mature physiologically, children typically achieve urinary and fecal continence, that is, they develop the ability to voluntarily retain their urine and feces. Coincident with the development of continence, children typically develop the ability to voluntarily urinate and defecate, and cease reflexive elimination. This development of continence and of voluntary elimination, in place of reflexive elimination, may be accelerated and/or guided by caregivers through associative and conditioning techniques of training the child. The term “continence training” is used to denote training for both continence itself and for the voluntary elimination that is associated with continence. Thus, the term “continence training” is synonymous with what is referred to as “toilet training” or “potty training” in some countries.

The methods of continence training of children vary widely between countries and cultures, and even within a given population. In certain cultures, the continence training is started at a relatively early age and involves intensive conditioning. For instance, continence training may begin prior to the child's first birthday, such as at 6 months of age or even earlier. The continence training methods used in these cultures are based on conditioning the child to eliminate waste upon some signal whenever the caregiver perceives that the child needs to urinate or defecate. Such conditioning methods are often extremely time-consuming and require the caregiver to learn and detect subtle signals from the child related to potential urination and defecation. With respect to urinary continence training, such a conditioning method may ultimately lead to earlier association of the physical sensation of bladder “fullness” with the possibility of voluntary urination into the designated receptacle. However, since the caregiver does not know the state of the bladder, a significant amount of time is wasted, since the bladder is often not sufficiently full to require emptying, or to produce the desired physical sensation of fullness in the child, at the time at which the caregiver attempts the conditioning.

In other cultures, the continence training is started at a much later age, e.g., when the child demonstrates an interest in the achievement of continence, with the intention being to minimize the psychological stress on the child by waiting until the child shows an interest. In these cultures, the start of continence training is typically postponed until the child reaches about 18 to 24 months of age. As a result, many children in these cultures are not fully continence-trained until age three or later, even though they are physiologically capable of achieving continence much earlier. In addition to increasing the cost of caring for the child, through necessitating the purchase of diapers, disposable training pants, etc., delayed continence training may also result in the child feeling low self-esteem, if his or her chronological peers are already continent, and may lead to issues with preschools or daycare facilities that require that children in their care are continent.

Many types of continence training methods and aids have been utilized, including progress charts, reward systems, urination “targets” for boys, electronic wetness alarms, progress scales, readiness questionnaires, and thermal and tactile training signals in disposable absorbent products, among many others. A key step in urinary continence training, in particular, is helping the child to learn to associate the physiological sensation of a “full” bladder with voluntary urination. One method that has been utilized to help the child learn this association is to ask the child to use the toilet on a regular basis. The caregiver may also analyze patterns in the child's behavior to determine when the child should use the toilet. This analysis requires the caregiver to have enough time to first observe the child's behavior closely, and secondly, remember the behavior to detect patterns. This becomes additionally difficult when multiple caregivers provide care such as with daycares, and when some behavior cannot be seen, such as actual times of urination, or activity levels during sleep.

### SUMMARY

In general, the present disclosure is directed to methods of predicting an incontinent event may happen. For example, in one embodiment, the method garment includes electronically monitoring a property of an absorbent article as the article is being worn by a wearer. The method also includes determining a change in the property of the article wherein the change is indicative of an incontinent event of the wearer. Further, the method includes predicting conditions indicative of a subsequent incontinent event based on the change in the property.

Another version of the present invention includes a method including electronically monitoring a property of an absorbent article as the article is being worn by a wearer. The method also includes determining a change in the property of the article wherein the change is indicative of an incontinent event of the wearer. Further, the method includes predicting conditions indicative of a subsequent incontinent event based on the change in the property. The predicting step includes comparing a series of incontinent events and conditions present at and before the incontinent events, and determining patterns in the conditions present at and before the incontinent events.

Finally, another version of the present invention includes a method including electronically monitoring a property of an absorbent article as the article is being worn by a wearer. The method also includes determining a change in the property of the article wherein the change is indicative of an incontinent event of the wearer. The method includes predicting conditions indicative of a subsequent incontinent event based on the change in the property. Further, the method includes activating an insult alarm to inform a caregiver and/or the wearer of the presence of an insult in the article. The predicting step comprises comparing a series of incontinent events and conditions present at and before the incontinent events, and determining patterns in the conditions present at and before the incontinent events.

### BRIEF DESCRIPTION OF THE DRAWINGS

FIG. 1 is a side perspective of an article shown in the form of a pair of training pants having a mechanical fastening system fastened on one side of the training pants and unfastened on the opposite side thereof;

FIG. 2 is a perspective view of the pants of FIG. 1;

FIG. 3 is a perspective view of the pants similar to FIG. 2 showing a housing of a monitoring system removed from the article;

FIG. 4 is a top plan view of the training pants of FIG. 1 with the pants in an unfastened, unfolded and laid flat condition, and showing the surface of the training pants that faces the wearer when worn and with portions cut away to show underlying features;

FIG. 5 is a cross-sectional view of the pants taken along the plane including line 5-5 of FIG. 4;

FIG. 6 is a schematic illustration of the pants and one embodiment of a monitoring system;

FIG. 7 is a block diagram for one embodiment illustrating an order of operation for components/devices, including a measuring device for measuring an electrical property of the pants and an analog-to-digital converter for converting an analog output from a measuring device into digital values to be read by a microprocessor;

FIG. 8 illustrates a graph of two theoretical properties with time on the x-axis and a measurement of the electronic response on the y-axis; and

FIG. 9 illustrates an alternative graph of two theoretical properties with time on the x-axis and a measurement of the electronic response on the y-axis.

Corresponding reference characters indicate corresponding parts throughout the drawings.

### DETAILED DESCRIPTION

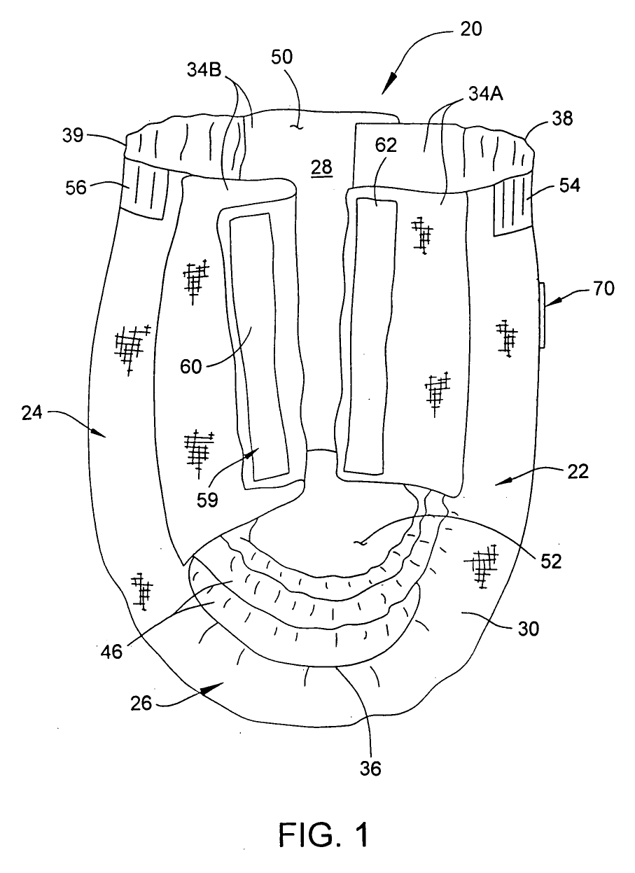

Referring now to the drawings and in particular to FIG. 1, an absorbent article is representatively illustrated therein in the form of children's toilet training pants and is indicated in its entirety by the reference numeral 20. The absorbent article 20 may or may not be disposable, which refers to articles that are intended to be discarded after a limited period of use instead of being laundered or otherwise conditioned for reuse. It is understood that the present invention is suitable for use with various other absorbent articles intended for personal wear, including but not limited to diapers, feminine hygiene products, incontinence products, medical garments, surgical pads and bandages, other personal care or health care garments, and the like without departing from the scope of the present invention.

By way of illustration only, various materials and methods for constructing training pants such as the pants 20 of the various aspects of the present invention are disclosed in PCT Patent Application WO 00/37009 published Jun. 29, 2000, by A. Fletcher et al; U.S. Pat. No. 4,940,464 issued Jul. 10, 1990, to Van Gompel et al.; U.S. Pat. No. 5,766,389 issued Jun. 16, 1998, to Brandon et al., and U.S. Pat. No. 6,645,190 issued Nov. 11, 2003, to Olson et al. which are incorporated herein by reference.

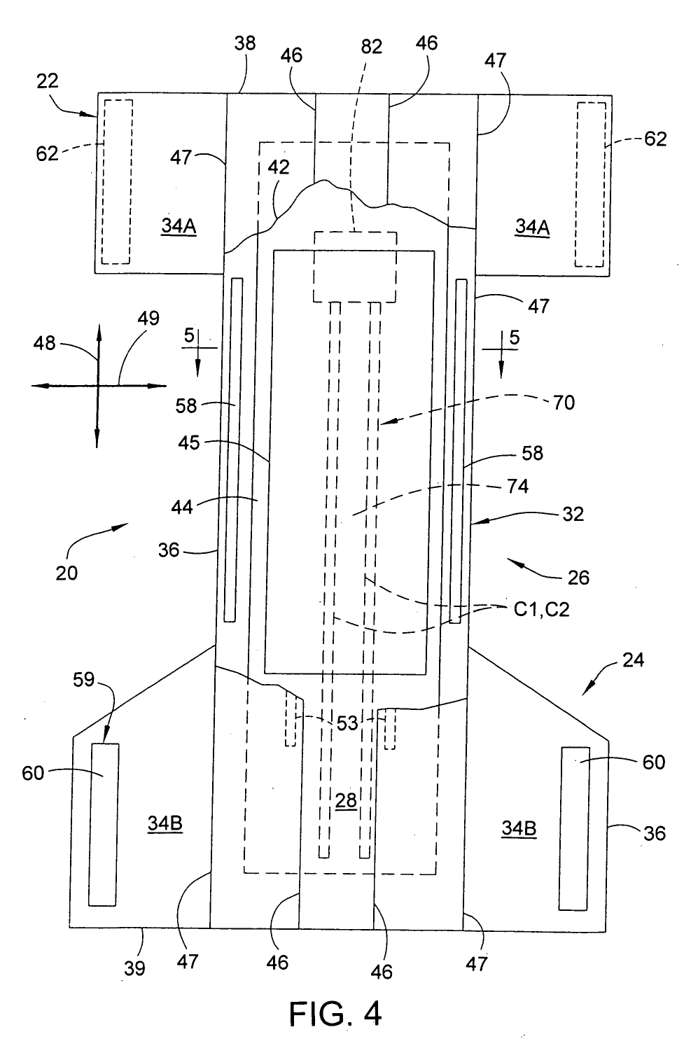

The pair of training pants 20 is illustrated in FIG. 1 in a partially fastened condition. The pants 20 define a longitudinal direction 48 of the pants and a lateral direction 49 thereof perpendicular to the longitudinal direction as shown in FIG. 4. The pants 20 further define a pair of longitudinal end regions, otherwise referred to herein as a front waist region, generally indicated at 22, and a back waist region, generally indicated at 24, and a center region, otherwise referred to herein as a crotch region, generally indicated at 26, extending longitudinally between and interconnecting the front and back waist regions 22, 24. The front and back waist regions 22, 24 comprise those portions of the pants 20, which when worn, wholly or partially cover or encircle the waist or mid-lower torso of the wearer. The crotch region 26 generally is that portion of the pants 20 which, when worn, is positioned between the legs of the wearer and covers the lower torso and crotch of the wearer. The pants 20 also define an inner surface 28 that faces toward the wearer when the pants are being worn, and an outer surface 30 opposite the inner surface. With additional reference to FIG. 4, the pair of training pants 20 has a pair of laterally opposite side edges 36 and a pair of longitudinally opposite waist edges (broadly, longitudinal ends), respectively designated front waist edge 38 and back waist edge 39.

In the embodiment of FIGS. 1-4, the training pants 20 comprise a generally rectangular central absorbent assembly, generally indicated at 32, and side panels 34A, 34B formed separately from and secured to the central absorbent assembly. The side panels 34A, 34B are permanently bonded along seams to the central absorbent assembly 32 in the respective front and back waist regions 22 and 24 of the pants 20. More particularly, the front side panels 34A can be permanently bonded to and extend transversely outward beyond side margins 47 of the absorbent assembly 32 at the front waist region 22, and the back side panels 34B can be permanently bonded to and extend transversely outward beyond the side margins of the absorbent assembly at the back waist region 24. The side panels 34A and 34B may be bonded to the absorbent assembly 32 using attachment means known to those skilled in the art such as adhesive, thermal or ultrasonic bonding.

The front and back side panels 34A and 34B, upon wearing of the pants 20, thus comprise the portions of the training pants 20 which are positioned on the hips of the wearer. The front and back side panels 34A and 34B can be permanently bonded together to form the three-dimensional configuration of the pants 20, or be releasably connected with one another such as by a fastening system 59 of the illustrated aspects. As is known in the art, the side panels 34A, 34B may comprise elastic material or stretchable but inelastic materials.

The absorbent assembly 32 is illustrated in FIGS. 1-3 as having a rectangular shape. However, it is contemplated that the absorbent assembly 32 may have other shapes (e.g., hourglass, T-shaped, I-shaped, and the like) without departing from the scope of this invention. It is also understood that the side panels 34A, 34B may instead be formed integrally with the absorbent assembly 32 without departing from the scope of this invention.

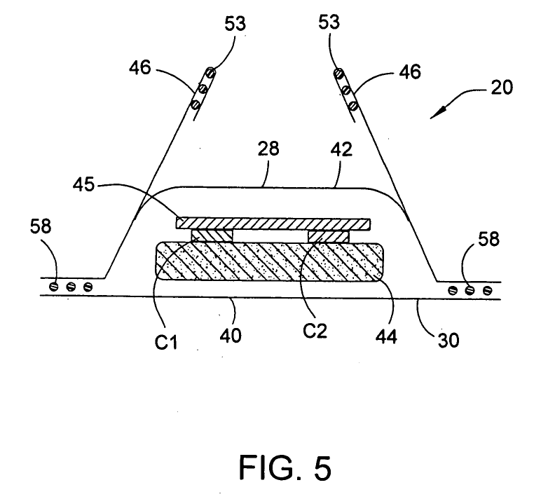

As shown best in FIGS. 4 and 5, the absorbent assembly 32 comprises an outer cover 40 and a bodyside liner 42 attached to the outer cover 40 in a superposed (opposed) relation therewith by adhesives, ultrasonic bonds, thermal bonds, pressure bonds, or other conventional techniques. The liner 42 is suitably joined to the outer cover 40 along at least a portion of the longitudinal ends of the pants 20. In addition, the liner 42 is suitably joined to the outer cover 40. The liner 42 is suitably adapted, i.e., positioned relative to the other components of the pants 20, for contiguous relationship with the wearer's skin during wear of the pants. The absorbent assembly 32 also comprises an absorbent structure 44 disposed between the outer cover 40 and the bodyside liner 42 for absorbing liquid body exudates exuded by the wearer and a surge management layer 45 disposed between the absorbent structure and the bodyside liner. A pair of containment flaps 46 are secured to the bodyside liner 42 for inhibiting the lateral flow of body exudates.

With the training pants 20 in the fastened position as partially illustrated in FIG. 1, the front and back waist regions are connected together by the fastening system 48 to define the three-dimensional pants configuration having a waist opening 50 and a pair of leg openings 52. The front and back waist edges 38 and 39 (e.g., longitudinal ends) of the training pants 20 are configured to encircle the waist of the wearer to define the waist opening 50 (FIG. 1) of the pants.

As illustrated in FIG. 4, a flap elastic member 53 can be operatively joined with each containment flap 46 in any suitable manner as is well known in the art. Suitable constructions and arrangements for the containment flaps 46 are generally well known to those skilled in the art and are described in U.S. Pat. No. 4,704,116 issued Nov. 3, 1987, to Enloe, which is incorporated herein by reference.

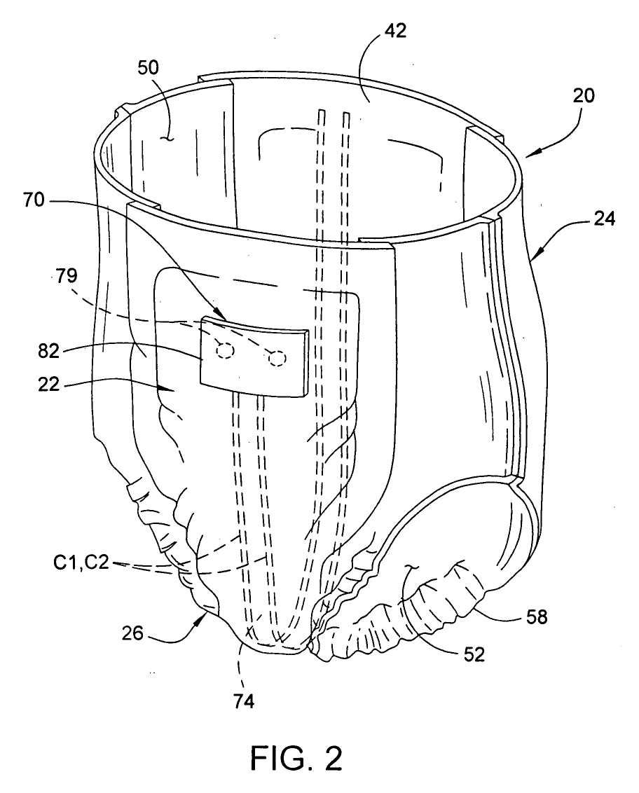

To further enhance containment and/or absorption of body exudates, the training pants 20 may comprise a front waist elastic member 54 (FIG. 1), a rear waist elastic member 56, and leg elastic members 58 (FIGS. 2-4), as are known to those skilled in the art. The flap elastic members 53, the waist elastic members 54 and 56, and the leg elastic members 58 can be formed of any suitable elastic material that is well known to those skilled in the art.

The fastening system 80 of the illustrated embodiment comprises laterally opposite first fastening components 60 adapted for refastenable engagement to corresponding laterally opposite second fastening components 62. In one embodiment, a front or outer surface of each of the fastening components 60, 62 comprises a plurality of engaging elements. The engaging elements of the first fastening components 60 are adapted to repeatedly engage and disengage corresponding engaging elements of the second fastening components 62 to releasably secure the pants 20 in its three-dimensional configuration. The fastening components 60, 62 can comprise any refastenable fasteners suitable for absorbent articles, such as adhesive fasteners, cohesive fasteners, mechanical fasteners, or the like. Suitable fastening systems are also disclosed in the previously incorporated PCT Patent Application WO 00/37009 published Jun. 29, 2000, by A. Fletcher et al. and the previously incorporated U.S. Pat. No. 6,645,190 issued Nov. 11, 2003, to Olson et al.

The outer cover 40 suitably comprises a material that is substantially liquid impermeable. The outer cover 40 may comprise a single layer of liquid impermeable material, or more suitably comprise a multi-layered laminate structure in which at least one of the layers is liquid impermeable. While it is not a necessity for the outer layer to be liquid permeable, it is suitable that it provides a relatively cloth-like texture to the wearer. Alternatively, the outer cover 40 may comprise a woven or non-woven fibrous web layer that has been totally or partially constructed or treated to impart the desired levels of liquid impermeability to selected regions that are adjacent or proximate the absorbent structure. The outer cover 40 may also be stretchable, and in some embodiments it may be elastomeric. Reference is made to U.S. Pat. No. 5,883,028, issued to Morman et al., U.S. Pat. No. 5,116,662 issued to Morman and U.S. Pat. No. 5,114,781 issued to Morman, all of which are hereby incorporated herein by reference, for additional information regarding suitable outer cover materials.

The bodyside liner 42 is suitably compliant, soft-feeling, and non-irritating to the wearer's skin. The bodyside liner 42 is also sufficiently liquid permeable to permit liquid body exudates to readily penetrate through its thickness to the absorbent structure 44. The bodyside liner 42 may also be stretchable, and in some embodiments it may be elastomeric.

Reference is made to U.S. patent application Ser. No. 09/563,417 filed on May 3, 2000 by Roessler et al., U.S. patent application Ser. No. 09/698,512 filed on Oct. 27, 2000 by Vukos et al., both of which are incorporated by reference herein, for additional information regarding bodyside liner material.

The absorbent structure 44 is disposed between the outer cover 40 and the bodyside liner 42, which can be joined together by any suitable means such as adhesives, ultrasonic bonds, thermal bonds, or the like. While the illustrated absorbent structure 44 is shown and described herein as extending from the crotch region 26 into both the front and back waist regions 22 and 24, it is contemplated that the absorbent structure may extend from the crotch region into only the front waist region, or only the back waist region, without departing from the scope of this invention.

The absorbent structure 44 is suitably compressible, conformable, non-irritating to a wearer's skin, and capable of absorbing and retaining liquids and certain body wastes. For example, the absorbent structure 44 may comprise cellulosic fibers (e.g., wood pulp fibers), other natural fibers, synthetic fibers, woven or nonwoven sheets, scrim netting or other stabilizing structures, superabsorbent material, binder materials, surfactants, selected hydrophobic materials, pigments, lotions, odor control agents or the like, as well as combinations thereof.

The materials may be formed into an absorbent web structure by employing various conventional methods and techniques known in the art. For example, the absorbent structure 44 may be formed by a dry-forming technique, an air forming technique, a wet-forming technique, a foam-forming technique, or the like, as well as combinations thereof. Methods and apparatus for carrying out such techniques are well known in the art. The absorbent structure 44 may alternatively comprise a coform material such as the material disclosed in U.S. Pat. No. 4,100,324 to Anderson, et al.; U.S. Pat. No. 5,284,703 to Everhart, et al.; and U.S. Pat. No. 5,350,624 to Georger, et al.; which are incorporated herein by reference.

Superabsorbent material is suitably present in the absorbent structure 44 in an amount of from about 0 to about 90 weight percent based on total weight of the absorbent structure.

The absorbent structure 44 may suitably have a density within the range of about 0.10 to about 0.35 grams per cubic centimeter. Superabsorbent materials are well known in the art and can be selected from natural, synthetic, and modified natural polymers and materials.

In one embodiment, the absorbent structure 44 may be stretchable so as not to inhibit the stretchability of other components to which the absorbent structure may be adhered, such as the outer cover 40 and bodyside liner 42. For example, the absorbent structure may comprise materials disclosed in U.S. Pat. Nos. 5,964,743, 5,645,542, 6,231,557, 6,362,389, and international patent application WO 03/051254, the disclosure of each of which is incorporated by reference herein.

The surge management layer 45 may be attached to various components of the article 20 such as the absorbent structure 44 and/or the bodyside liner 42 by methods known in the art, such as by adhesive, ultrasonic or thermal bonding. The surge management layer 45 helps to decelerate and diffuse surges or gushes of liquid that may be rapidly introduced into the absorbent structure 44 of the article 20. Desirably, the surge management layer 45 can rapidly accept and temporarily hold the liquid prior to releasing the liquid into the storage or retention portions of the absorbent structure 44. Examples of suitable surge management layers 45 are described in U.S. Pat. No. 5,486,166; and U.S. Pat. No. 5,490,846. Other suitable surge management materials are described in U.S. Pat. No. 5,820,973. The entire disclosures of these patents are incorporated by reference herein.

Optionally, a substantially liquid permeable wrapsheet (not shown) may surround the absorbent structure 44 to help maintain the integrity of the absorbent structure 44.

The training pants 20 include a monitoring system for detecting the presence of urine (broadly, an insult) within the pants 20. Although the monitoring system may take on other configurations, this particular configuration of the system monitors an electrical characteristic of the pants and determines whether the child has urinated in the pants using such electrical characteristic. After detection of urine, the system may inform a caregiver and/or a child of the presence of the urine by generating an insult alarm. The alarm may be, for example, either an auditory signal, such as a song, or a tactile signal, such as temperature change, or a visual signal, such as a blinking light. It is understood that the system may comprise a device for sending a wireless signal to a remote auditory, visual, tactile or other sensory alarm.

The present invention presents a method to predict when a future incontinent event may happen by collecting and analyzing data to recognize patterns in prior incontinent events. Further, the method of the present invention utilizes these patterns to educate the caregiver and/or the incontinent wearer to aid in either continent training, or to provide the caregiver information to better care for an incontinent wearer.

The method of the present invention electronically monitors properties of the wearer and properties of the pant 20 on a regular basis, for example by using a monitoring system 70. One of the properties of the pant 20 that is monitored may change when an insult occurs. This insult indicates an incontinent event has occurred and the method uses the incontinent event as trigger to review the properties of the wearer and pant 20 monitored before and during the incontinent event. Changes in these properties may show patterns which can then be used to predict when incontinent events are likely.

In one particularly suitable embodiment, shown best in FIGS. 2-4, one example of the monitoring system is generally indicated by reference numeral 70. The monitoring system 70 includes a sensor for detecting the electrical property (e.g., resistance Ω) of the article. The sensor includes a pair of spaced apart generally parallel conductors C1, C2 disposed within the pants 20 that define a monitoring area 74 of the pants disposed between the conductors. The conductors C1, C2 may be constructed of any material that is generally electrically conductive. For example, the conductors may be constructed of metal strips (e.g., aluminum strips), metal films, coated films, conductive polymers, conductive inks, or conductive threads. Other conductors are within the scope of this invention. The conductors C1, C2 extend longitudinally from the front waist region 22, through the crotch region 26, to the back waist region 24 of the pants 20. As shown best in FIG. 5, the conductors C1, C2 are disposed within the absorbent assembly 32 between the absorbent structure 44 and the surge management layer 45, although the conductors may be disposed at other locations without departing from the scope of this invention.

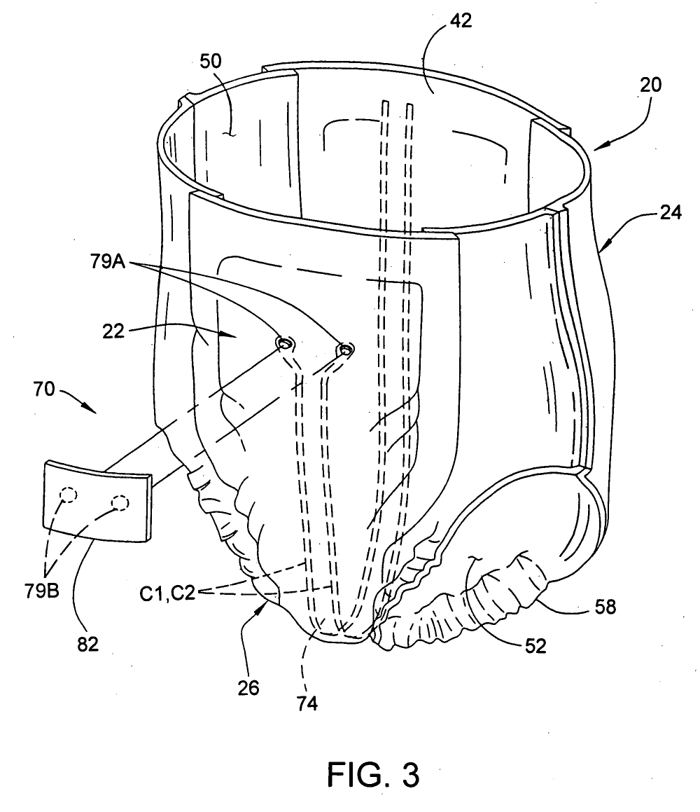

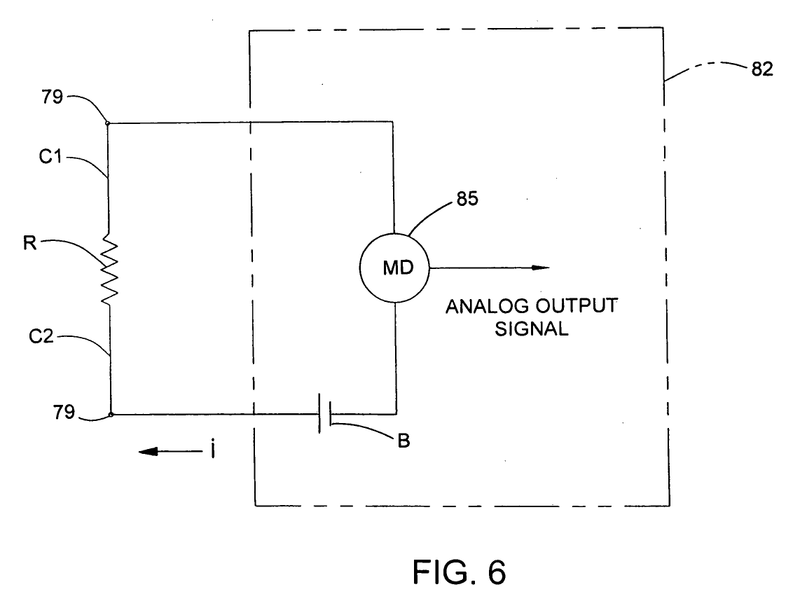

Current i from a current source B (illustrated schematically in FIG. 6) runs through the conductors C1, C2 of the sensor. The current source i may be a direct current source such as a battery (as illustrated), or an alternating current source. In the illustrated embodiment, the conductors C1, C2 are electrically connected to the current source by way of electrically conductive snap fasteners 79. Other ways of electrically connecting the conductors to the current source are within the scope of this invention. As illustrated in FIG. 3, each corresponding end of each conductor C1, C2 is connected to a first snap fastener member 79A located in the front waist region 22 of the pants 20. Alternatively, the first snap fastener member may be located in the back waist region 24, or other locations on the pants 20. A housing 82 that houses the current source i has corresponding second snap fastener elements 79B for engaging the first snap fasteners 79A and securing the housing to the pants 20. In addition to the current source i, the housing 82 of the present embodiment also houses the remaining components of the monitoring system 70 that will be described hereinafter, although it is contemplated that the housing may include only some or none of the remaining components. In the illustrated embodiment the housing 82 is releasably secured to the pants 20 by way of the snap fasteners 79, although it is understood that the housing may be permanently secured to the pants without departing from the scope of this invention.

A measuring device 85 (FIG. 6) of the sensor measures an electrical property of the monitoring area 74 of the pants 20. In one embodiment, the resistance R of the monitoring area 74 of the pants 20 is measured. Because the conductors C1, C2 are spaced apart, current from the current source i must pass through the monitoring area 74 to complete the circuit. As illustrated schematically in FIG. 6, the monitoring area 74 acts essentially as a resistor, as indicated by reference character R. When the monitoring area 74 is dry (e.g., before the presence of an insult), the resistance of the monitoring area is relatively high, for example, some resistance above 200 kΩ. When the monitoring area 74 is wetted, for example by an insult, its resistance drops, for example, to some resistance less than 200 KΩ because of the electrically conductive nature of urine.

In another embodiment, the conductance of the monitoring area 74 of the pants 20 is measured. As stated above, urine is electrically conductive and the article 20 generally is not electrically conductive. Therefore, when the monitoring area 74 of the pants 20 is wetted, its conductance is greater than when it is dry. Other electrical properties of the pants 20, including impedance, may be measured without departing from the scope of this invention.

The measuring device 85 produces an analog output signal (FIG. 6) indicative of the electrical property of the monitoring area 74 of the pants 20. For example, the measuring device 85 can measure a resistance drop across the monitoring area 74, and produce an analog output signal corresponding to the voltage drop. The output voltage signal can be used to determine other electrical properties, such as resistance or current, by performing suitable calculations known in the art or using a reference table. For example, as is well known in the art, the voltage drop is indicative of the resistance of the pants when the current is constant. Thus, as explained below in further detail, the resistance of the pants 20 may be determined using the analog output signal of the measuring device 85.

In one embodiment, a percent difference test is conducted on the measured resistance of the pants 20 to determine the presence (or lack thereof) of an insult in the pants as the pants are being worn by the wearer. In this embodiment, a proportional difference (e.g., a percent difference) in the measured electrical property of the monitoring area of the pants over time is determined, and this proportional difference is compared with a difference threshold value to determine if an insult is present in the pants.

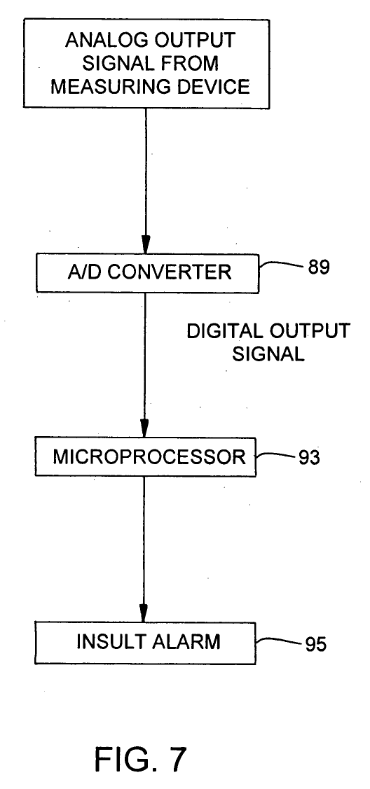

In one example of this embodiment, illustrated in FIG. 7, an analog-to-digital converter 89 receives the analog output signal from the measuring device 85 and converts the signal into a digital output signal. A microprocessor 93 receives the digital output signal, which is representative of the magnitude of the electrical property (e.g., resistance) of the pants 20, and analyzes it to determine the presence of an insult. If the microprocessor 93 detects the presence of an insult, then it may activate the insult alarm 95. The analog-to-digital converter 89 is a conventional device for converting analog signals into digital signals that can be read by a microprocessor. The analog-to-digital converter 89 of the present embodiment may be a separate device or it may be a component of the microprocessor 93. For illustrative purposes, the electrical property will hereinafter be referred to as resistance although, as noted above, it may be any variable property of the garment which reflects wetness.

Thus, the microprocessor 93 records and monitors the time when an insult take place. Additionally, the microprocessor 93 may monitor and record when a series of insults take place. The monitoring may indicate that on four subsequent days insults took place at 7:00 p.m., 6:50 p.m., 7:10 p.m., and 7:02 p.m., respectively. Based on this information, the microprocessor 93 would predict that sometime between 6:50 p.m. and 7:10 p.m. an incontinent event may take place. This set of conditions indicative of a subsequent incontinent event, between 6:50 p.m. and 7:10 p.m., may then be communicated to the caregiver and/or the wearer. The caregiver and/or the wearer may be able to use this information to modify behavior to eliminate the incontinent event. In the case of a toddler, a caregiver may encourage the child to use the toilet about 6:45 p.m. The monitoring system 70 may communicate to the caregiver visually, audibly, or via a cell phone, or other electronic device.

In another embodiment, the monitoring system 70 may communicate to the caregiver and/or the wearer when the conditions indicative of a subsequent incontinent event occur. For example, using the above date, the monitoring system 70 may activate at 6:40 p.m. indicating to the caregiver and/or the wearer for the wearer to use the toilet. The monitoring system 70 may escalate the communication, either getting louder, or more frequent.

The monitoring system 70 may electronically monitor more than just a property indicative of an incontinent event, such as a wet pant 20. For example the monitoring system 70 may electronically monitor a second property which is indicative of the physical position of the body of the wearer, sitting, standing, lying prone, lying supine or lying on the side of the body. Changes in this property may be analyzed in conjunction with the property indicative of an incontinent event to determine if the wearer changes position in a predictable manner before a void. For example, the wearer may sleep generally on their back, but during lighter sleep patterns, they may roll onto their stomachs, which may then be correlated with an incontinent event. A device suitable to detecting body position is the HAAM-301B Piezo-Resistive 3-Axis Acceleration Sensor available from Hokuriku USA, Ltd. of Huntsville, Ala.

The monitoring system 70 may electronically monitor a second property which is indicative of the physical activity of the wearer, for example stationary, restless, active, slightly active and very active. Changes in this property may also be analyzed in conjunction with the other properties described to determine if the wearer changes activity in a predictable manner before a void. For example, during periods of exciting active play, the wearer may become forgetful of the need to urinate. As activity decreases rapidly, an incontinent event may occur. Thus a pattern of decreased activity may indicate an incontinent event. Alternatively, parents may be familiar with the “potty dance” where the child makes smaller quick movements because of the urge to urinate. Here a pattern of increased activity may indicate an incontinent event. Further, perhaps a set time delay after waking may indicate an incontinent event. These activity levels also may be analyzed for patterns and correlated with incontinent events and be used as a prediction of a subsequent incontinent event. A device suitable to detecting activity level is the HAAM-301B Piezo-Resistive 3-Axis Acceleration Sensor available from Hokuriku USA, Ltd. of Huntsville, Ala.

The monitoring system 70 may electronically monitor a second property which is indicative of the physical location of the wearer, for example longitude and latitude as determined by a GPS receiver. Changes in this property may also show patterns which may be indicative of incontinent events. For example, when the physical location of the wearer indicates that the child has been stationary in the kitchen or dining area, potentially eating or drinking, a pattern may develop that a given period after leaving the kitchen, an incontinent event may occur. Alternatively, the physical location of the wearer may indicate that the wearer is at home or at a daycare facility. Different patterns of drinking, activity, bathroom availability, etc. at these different locations may influence the patterns of incontinent events.

The monitoring system 70 may electronically monitor a second property which is indicative of an intake of a substance by the wearer such a liquid, a solid, or a drug. For example this property may be data the wearer or caregiver may enter via a keyboard, mouse or touchpad indicating that the wearer has eaten, has drunk or has been given a drug. The property may be movement of the throat, which may be detected using a motion detector located on a necklace. A pattern may show that a given time after drinking an incontinent event may occur.

The monitoring system 70 may predict conditions indicative of a subsequent incontinent event a number of ways. The monitoring system 70 may compare the changes in the first and the second properties that are being monitored and compare them with known patterns predictive of incontinent events. Alternatively the monitoring system 70 may look for individual incontinent events as indicated by the first property and then looked to changes in the second property which preceded the incontinent event. Upon finding an instance of a change in the second property followed by an incontinent event, the monitoring system 70 may then compare other incontinent events for a similar cause and effect relationship. Multiple second properties may be compared to find more complex relationships and patterns.

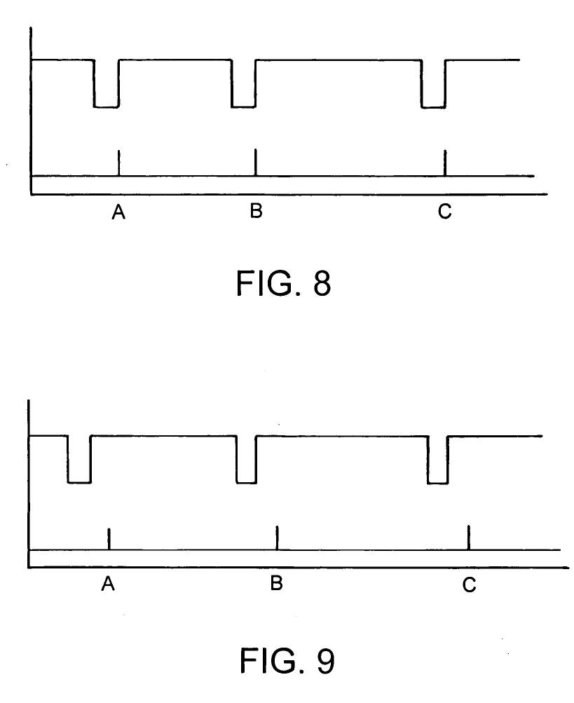

FIG. 8 illustrates the graph of two theoretical properties with time on the x-axis and a measurement of the electronic response on the y-axis. The lower line indicates the response of the first property indicative of an incontinent event, specifically three incontinent events A, B and C. The upper line indicates the response of the second property. The response of the second property before the incontinent event indicates a decrease in the response shortly before an incontinent event, for example reducing activity (play) before urinating. This pattern may be predictive of a subsequent incontinent event.

FIG. 9 illustrates a graph of two theoretical properties with time on the x-axis and a measurement of the electronic response on the y-axis. The lower line indicates the response of the first property indicative of an incontinent event, specifically three incontinent events A, B and C. The upper line indicates the response of the second property. The response of the second property before the incontinent event indicates a decrease in the response followed by an increase in the response shortly before an incontinent event. This pattern may be predictive of a subsequent incontinent event.

When introducing elements of the present invention or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A method of predicting when an incontinent event may happen, said method comprising:
electronically monitoring a property of an absorbent article as the article is being worn by a wearer;
determining a change in the property of the article wherein the change is indicative of an incontinent event of the wearer; and
predicting conditions indicative of a subsequent incontinent event based on the change in the property.

2. The method as set forth in claim 1 further comprising communicating to a caregiver and/or the wearer the conditions indicative of the subsequent incontinent event.

3. The method as set forth in claim 1 further comprising communicating to a caregiver and/or the wearer when conditions indicative of the subsequent incontinent event occur.

4. The method as set forth in claim 1 further comprising electronically monitoring a second property of the absorbent article and determining a change in the second property wherein the change in the second property is indicative of the physical position of the body of the wearer.

5. The method as set forth in claim 1 further comprising electronically monitoring a second property of the absorbent article and determining a change in the second property wherein the change in the second property is indicative of the physical activity level of the wearer.

6. The method as set forth in claim 1 further comprising electronically monitoring a second property of the absorbent article and determining a change in the second property wherein the second property is a longitude and a latitude of the wearer.

7. The method as set forth in claim 1 further comprising electronically monitoring a second property of the absorbent article and determining a change in the second property wherein the change in the second property is indicative of an intake of substance by the wearer.

8. The method as set forth in claim 7 wherein the electronically monitoring of the second property comprises receiving input from a keyboard, mouse or touchpad.

9. The method as set forth in claim 1 wherein the monitored property of the article is resistance or conductance.

10. The method as set forth in claim 1 further comprising activating an insult alarm to inform a caregiver and/or the wearer of the presence of an insult in the article.

11. The method as set forth in claim 1 wherein the predicting step comprises comparing a series of incontinent events and conditions present at and before the incontinent events, and determining patterns in the conditions present at and before the incontinent events.

12. The method as set forth in claim 11 wherein the series of incontinent events include at lease 10 incontinent events.

13. The method as set forth in claim 11 wherein the patterns in the conditions are times of day.

14. The method as set forth in claim 11 wherein the patterns in the conditions are activity levels.

15. The method as set forth in claim 14 wherein the activity levels decrease preceding an incontinent event.

16. The method as set forth in claim 14 wherein the activity levels increase preceding an incontinent event.

17. The method as set forth in claim 14 wherein the patterns in the conditions are a set time delay after awakening from slumber.

18. The method as set forth in claim 11 wherein the patterns in the conditions are a set time delay after an intake of a substance by the wearer.

19. A method of predicting when an incontinent event may happen, said method comprising:
electronically monitoring a property of an absorbent article as the article is being worn by a wearer;
determining a change in the property of the article wherein the change is indicative of an incontinent event of the wearer; and
predicting conditions indicative of a subsequent incontinent event based on the change in the property; wherein the predicting step comprises comparing a series of incontinent events and conditions present at and before the incontinent events, and determining patterns in the conditions present at and before the incontinent events.

20. The method as set forth in claim 19 wherein the monitored property of the article is resistance or conductance.

21. The method as set forth in claim 19 further comprising activating an insult alarm to inform a caregiver and/or the wearer of the presence of an insult in the article.

22. The method as set forth in claim 19 wherein the series of incontinent events include at lease 10 incontinent events.

23. The method as set forth in claim 19 wherein the patterns in the conditions are times of day.

24. A method of predicting when an incontinent event may happen, said method comprising:
electronically monitoring a property of an absorbent article as the article is being worn by a wearer;
determining a change in the property of the article wherein the change is indicative of an incontinent event of the wearer;
predicting conditions indicative of a subsequent incontinent event based on the change in the property; and
activating an insult alarm to inform a caregiver and/or the wearer of the presence of an insult in the article; wherein the predicting step comprises comparing a series of incontinent events and conditions present at and before the incontinent events, and determining patterns in the conditions present at and before the incontinent events.
